(19) United States
(12) Patent Application Publication
(10) Pub. No.: US 2024/0367110 A1
(43) Pub. Date: Nov. 7, 2024

(54) A Booster Unit and a Reverse Osmosis Filtration System

(71) Applicant: 3M INNOVATIVE PROPERTIES COMPANY, St. Paul, MN (US)

(72) Inventors: Biyong Qiu, Shanghai (CN); Jianhua Wang, Shanghai (CN); John M. Pilgrim, Woodbury, MN (US); Dian Zheng, Woodbury, MN (US); Jie Ying Luo, Shanghai (CN); Jon P. Kragness, Farmington, MN (US)

(21) Appl. No.: 18/565,624

(22) PCT Filed: May 31, 2021
(86) PCT No.: PCT/CN2021/097201

§ 371 Date: Nov. 30, 2023

(51) Int. Cl. B01D 61/10; B01D 61/02; B01D 61/04; B01D 61/08; C02F 1/28; C02F 1/44

(52) U.S. Cl. CPC B01D 61/10; B01D 61/025; B01D 61/04; B01D 61/08; C02F 1/283; C02F 1/441; C02F 1/444; B01D 2311/04; C02F 2301/026; C02F 2307/06

(57) ABSTRACT

A booster unit (40) and a reverse osmosis filtration system (100). The booster unit (40) includes: a booster pump (45), wherein the pump fluid outlet (4512) is connected to a fluid outlet port (P2); and a housing. The housing includes an outer housing (41) and an inner housing (42) at least partially mounted in the outer housing (41). The booster pump (45) is provided in an inner cavity of the inner housing (42). A fluid channel is formed between the outer housing (41) and the inner housing (42); a fluid inlet of the fluid channel is connected to a fluid inlet port (P1) of the booster unit (40), and a fluid outlet of the fluid channel is connected to a pump fluid inlet (4511) of the booster pump (45). The reverse osmosis filtration system (100) comprises the booster unit (40).

### TECHNICAL FIELD

The present disclosure relates to the field of fluid filtration, and more specifically, relates to a booster unit for a reverse osmosis filtration system and a reverse osmosis filtration system having the booster unit.

### BACKGROUND

The content of this part provides only background information related to the present disclosure, and does not necessarily constitute the prior art.

A reverse osmosis filtration system is a commonly used filtration system in filtration of drinking water for residents. In the reverse osmosis filtration system, in order to ensure that raw water flowing into a reverse osmosis filter has sufficient intake water pressure, a booster unit including a booster pump is usually provided in a water inlet pipeline of the reverse osmosis filtration system. In actual applications of such a reverse osmosis filtration system provided with the booster unit, the booster pump in operation produces vibration and noise, affecting user experience of the reverse osmosis filtration system. In addition, the booster pump in operation generates heat, and if heat dissipation is not performed in time, then the temperature of the booster pump rises adversely, thereby affecting use of the booster pump and the reverse osmosis filtration system.

Therefore, the above reverse osmosis filtration system is expected to be improved, so as to reduce vibration and noise while ensuring sufficient intake water pressure, improve user experience, provide effective cooling, and ensure normal operation of the reverse osmosis filtration system.

### SUMMARY

An objective of the present disclosure is to reduce noise generated by a reverse osmosis filtration system in operation, and another objective of the present disclosure is to reduce vibration of a reverse osmosis filtration system in operation, so as to improve user experience of the reverse osmosis filtration system. Still another objective of the present disclosure is to provide effective cooling when a reverse osmosis filtration system is in operation, so as to ensure normal operation of the reverse osmosis filtration system.

According to an aspect of the present disclosure, a booster unit is provided, and the booster unit is provided with a fluid inlet port and a fluid outlet port. The booster unit comprises: a booster pump, provided with a pump fluid inlet and a pump fluid outlet, wherein the pump fluid outlet is connected to the fluid outlet port; and a housing, wherein the booster pump is provided in the housing. The housing comprises an outer housing and an inner housing; the inner housing is at least partially mounted in the outer housing; the booster pump is provided in an inner cavity of the inner housing. A fluid channel is formed between the outer housing and the inner housing; a fluid inlet of the fluid channel is connected to the fluid inlet port, and a fluid outlet of the fluid channel is connected to the pump fluid inlet.

The booster pump is movable relative to the housing.

In an embodiment, the housing further comprises an upper cover, and the upper cover is mounted to an open end of the inner housing so that the upper cover and the inner housing together define an accommodation space for accommodating the booster pump. The bottom of the booster pump is supported by a lower elastic member so that the booster pump is movable in an axial direction of the housing in the accommodation space.

In an embodiment, the booster pump is provided with an inlet cylindrical portion surrounding the pump fluid inlet and an outlet cylindrical portion surrounding the pump fluid outlet; one end of the fluid outlet port passes through the upper cover, and is sealedly joined to the outlet cylindrical portion, and the fluid outlet port is movable in the axial direction relative to the outlet cylindrical portion. The booster unit is further provided with a first intermediate port; one end of the first intermediate port is sealedly joined to the inlet cylindrical portion; another end of the first intermediate port is fluidly connected to the fluid outlet of the fluid channel; the first intermediate port is movable in the axial direction relative to the inlet cylindrical portion.

In an embodiment, the booster unit further comprises a first seal and a second seal; the one end of the fluid outlet port is sealedly joined to the outlet cylindrical portion by means of the first seal, and the one end of the first intermediate port is sealedly joined to the inlet cylindrical portion by means of the second seal.

In an embodiment, the other end of the first intermediate port is fluidly connected to the fluid outlet of the fluid channel by means of a second intermediate port.

In an embodiment, the upper cover is provided with a first cylindrical portion through which the fluid outlet port passes and a second cylindrical portion through which the first intermediate port passes. The first cylindrical portion and the second cylindrical portion extend from the upper cover towards the inside of the accommodation space; the first cylindrical portion is adapted to be spaced apart from the outlet cylindrical portion in the axial direction, and the second cylindrical portion is adapted to be spaced apart from the inlet cylindrical portion in the axial direction.

In an embodiment, the first cylindrical portion is aligned with the outlet cylindrical portion, and/or the second cylindrical portion is aligned with the inlet cylindrical portion.

In an embodiment, a first baffle is fixed to the fluid outlet port; the first baffle is located in the axial direction between the first cylindrical portion and the outlet cylindrical portion. A second baffle is fixed to the first intermediate port; the second baffle is located in the axial direction between the second cylindrical portion and the inlet cylindrical portion.

In an embodiment, the booster unit is provided with a first upper elastic member and a second upper elastic member. The first upper elastic member surrounds the outlet cylindrical portion, and is configured to bias the first baffle towards the first cylindrical portion. The second upper elastic member surrounds the inlet cylindrical portion, and is configured to bias the second baffle towards the second cylindrical portion.

In an embodiment, the booster unit is further provided with a flexible mat, and the flexible mat is configured to cover the upper cover.

In an embodiment, the booster unit is further provided with a cushion, and the cushion is provided between an outer peripheral wall of the booster pump and an inner wall of the inner housing.

In an embodiment, the fluid channel extends helically in the axial direction of the housing.

In an embodiment, the fluid channel comprises a first flow channel and a second flow channel; the first flow channel and the second flow channel are fluidly connected to each other, and extend helically and alternately with each other in the axial direction of the housing; the first flow channel has the fluid inlet, and the second flow channel has the fluid outlet.

According to another aspect of the present disclosure, a reverse osmosis filtration system is provided, comprising: a preliminary filter unit, configured to filter raw water to obtain purified water; and a reverse osmosis filter unit, configured to further filter the purified water flowing out of the preliminary filter unit. The reverse osmosis filtration system further comprises the booster unit according to the present disclosure, and the booster unit is provided upstream of a water inlet of the reverse osmosis filter unit.

In an embodiment, an outlet of the preliminary filter unit is connected to the fluid inlet port of the booster unit, and the fluid outlet port of the booster unit is connected to the water inlet of the reverse osmosis filter unit.

According to the present disclosure, the booster unit is provided with the two-housing structure having the fluid channel therein, and a fluid is caused to flow in the fluid channel in the two-housing structure before the fluid is pressurized by the booster pump, thereby forming a fluid acoustic barrier, providing effective cooling while restricting transmission of noise, and reducing costs. In addition, axial flexibility and radial flexibility are provided between the booster pump and the housing, thereby preventing vibration of the booster pump in operation from being transmitted to the housing. The flexible mat covering the upper cover is advantageously provided, thereby further restricting noise from being transmitted to the outside of the housing of the booster unit. The booster unit and the reverse osmosis filtration system according to the present disclosure can effectively reduce vibration and noise while ensuring sufficient intake water pressure, and provide effective cooling at reduced costs.

### BRIEF DESCRIPTION OF THE DRAWINGS

Embodiments of the present disclosure are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 shows a schematic block diagram of a reverse osmosis filtration system according to a first embodiment of the present disclosure;

FIG. 2 shows a perspective view of a booster unit of the reverse osmosis filtration system according to the first embodiment of the present disclosure;

FIG. 3 shows a partial cutaway view of the booster unit shown in FIG. 2, and shows a structure of a housing of the booster unit;

FIG. 4 shows a perspective view of an inner housing of the booster unit shown in FIG. 2;

FIG. 5 shows another partial cutaway view of the booster unit shown in FIG. 2, and shows an internal structure of the booster unit;

FIG. 6 shows a partial enlarged view of the cutaway view shown in FIG. 5, and shows an upper part of the booster unit; and

FIG. 7 shows a top view of a cushion of the booster unit shown in FIG. 5.

### DETAILED DESCRIPTION

The following description is merely exemplary in nature and is not intended to limit the present disclosure, applications, and uses. It should be understood that in all these accompanying drawings, similar reference numerals indicate the same or similar components and features. The accompanying drawings illustratively show the idea and principles of the embodiments of the present disclosure, but do not necessarily show specific size of each embodiment of the present disclosure and the scale thereof. In some parts of specific accompanying drawings, related details or structures of the embodiments of the present disclosure may be illustrated in an exaggerated manner.

The reverse osmosis filtration system according to the present disclosure may be used to filter municipal tap water, and may also be used to filter other fluids. The reverse osmosis filtration system and the booster unit thereof according to the present disclosure will be illustrated below with reference to the accompanying drawings by taking the application of the reverse osmosis filtration system in municipal tap water filtration as an example.

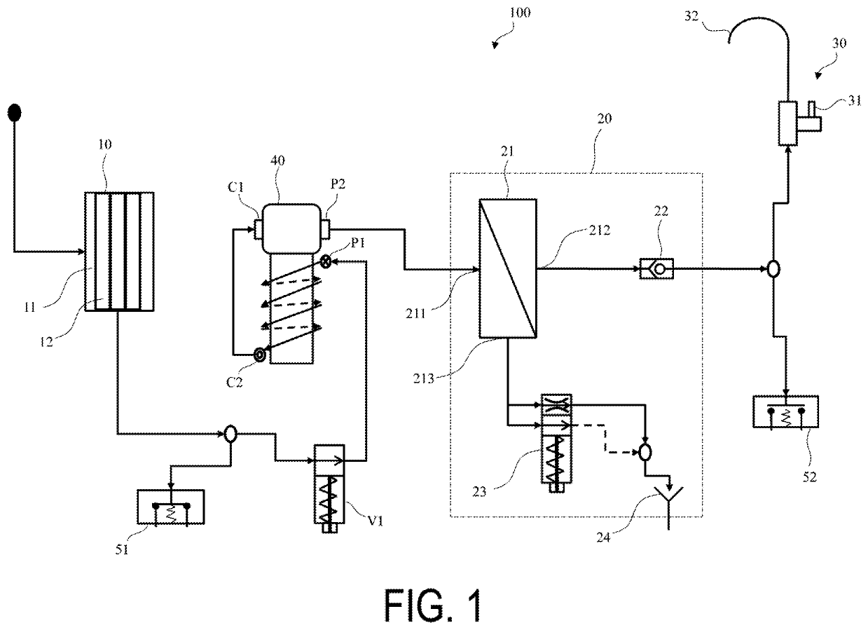

FIG. 1 shows a schematic block diagram of a reverse osmosis filtration system 100 according to a first embodiment of the present disclosure.

As shown in FIG. 1, the reverse osmosis filtration system 100 includes a preliminary filter unit 10, a reverse osmosis filter unit 20, and a faucet 30. The preliminary filter unit 10 is configured to perform preliminary filtration on raw water (such as municipal tap water), so as to filter out particulate impurities or pathogenic bacteria in the raw water, obtain purified water containing minerals, and prevent the particulate impurities in the raw water from entering a downstream apparatus to cause blockage. In this example, the preliminary filter unit 10 includes a first filtration medium 11 and a second filtration medium 12. The first filtration medium 11 may be a collapsible microfiltration or ultrafiltration medium. The second filtration medium 12 is provided in the first filtration medium 11, and may be a hollow activated carbon rod.

The purified water obtained after filtration performed by the preliminary filter unit 10 flows to the downstream reverse osmosis filter unit 20 via a water intake solenoid valve V1, and is further filtered, so as to obtain pure water without minerals. The reverse osmosis filter unit 20 may be a conventional reverse osmosis filter unit, and includes a reverse osmosis membrane filter element 21, a check valve 22, a flow limiting apparatus 23, and a drainage apparatus 24. The reverse osmosis membrane filter element 21 includes a water inlet 211, a pure water port 212, and a concentrated water port 213. The purified water from the preliminary filter unit 10 flows into the reverse osmosis membrane filter element 21 via the water inlet 211. After the purified water flows through the reverse osmosis membrane filter element 21, pure water and concentrated water are separately obtained. The pure water flows out of the pure water port 212, and flows to the faucet 30 via the check valve 22. The concentrated water flows out of the concentrated water port 213, flows through the flow limiting apparatus 23, and is drained via the drainage apparatus 24. The reverse osmosis filtration system 100 is further provided with a low-pressure protection switch 51 and a high-pressure protection switch 52. When water pressure in a raw water pipeline is too low, for example when a municipal tap water pipeline stops supplying water, the low-pressure protection switch 51 causes the reverse osmosis filtration system 100 to stop operating. When a water storage tank (not shown) of the reverse osmosis filter unit 20 is filled up with pure water or pressure in a downstream pipeline of the check valve 22 reaches a predetermined pressure value, the high-pressure protection switch 52 causes the reverse osmosis filter unit 20 to stop producing water.

When pressure of the purified water flowing into the reverse osmosis membrane filter element 21 is insufficient, it is difficult for the purified water to pass through the reverse osmosis membrane filter element 21, thereby affecting a water production rate of the reverse osmosis membrane filter element 21, causing the reverse osmosis membrane filter element 21 not to operate stably, and therefore possibly affecting use of the reverse osmosis filtration system.

Therefore, the reverse osmosis filtration system 100 according to the present disclosure is further provided with a booster unit 40. The booster unit 40 is provided upstream of the reverse osmosis filter unit 20, so as to increase intake water pressure of the reverse osmosis membrane filter element 21. Herein, “upstream” and “downstream” are defined according to a flow direction of a fluid in the reverse osmosis filtration system 100. Preferably, as shown in FIG. 1, the booster unit 40 is provided between the preliminary filter unit 10 and the reverse osmosis filter unit 20, and more specifically, is provided between the water intake solenoid valve V1 and the reverse osmosis filter unit 20. The purified water flowing out of the preliminary filter unit 10 flows into the booster unit 40 via the water intake solenoid valve V1, thereby preventing particulate impurities in the raw water from flowing into the booster unit 40 to cause blockage.

The booster unit 40 is configured to cause the purified water flowing out of the preliminary filter unit 10 to be pressurized before flowing into the reverse osmosis filter unit 20, so as to ensure sufficient intake water pressure of the reverse osmosis membrane filter element 21. The booster unit 40 is provided with a fluid inlet port P1 and a fluid outlet port P2. The purified water flows into the booster unit 40 via the fluid inlet port P1, flows out of the booster unit 40 via the fluid outlet port P2 after being pressurized by the booster unit 40, and flows to the water inlet 211 of the reverse osmosis membrane filter element 21.

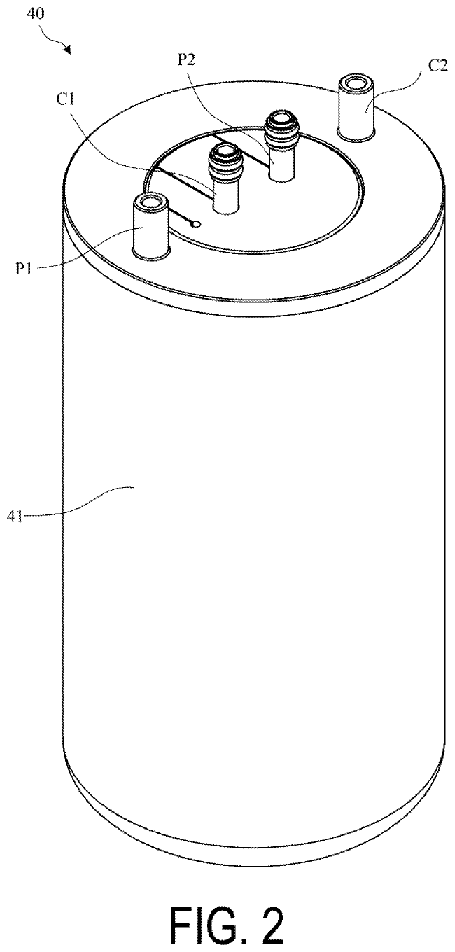

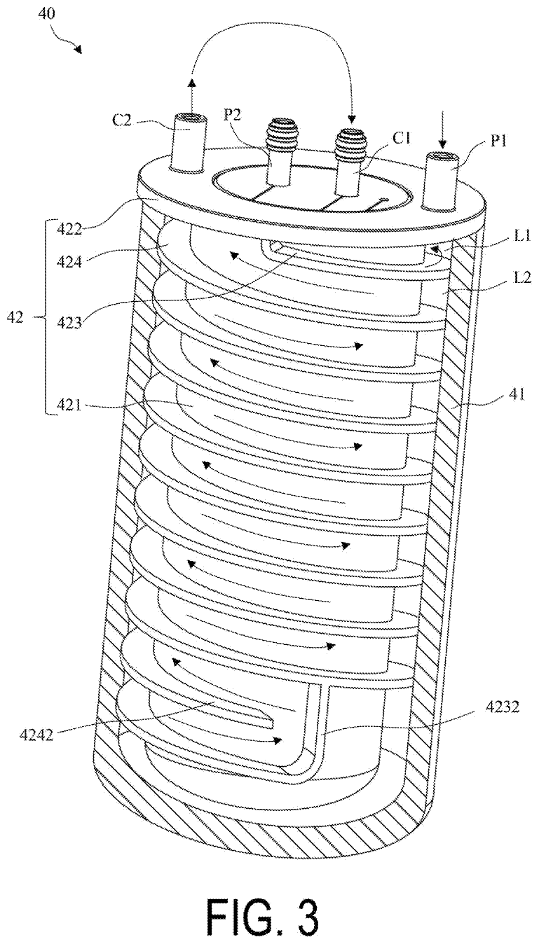

FIG. 2 shows a perspective view of the booster unit 40, and FIG. 3 shows a partial cutaway view of the booster unit 40. The booster unit 40 includes a housing, and the housing has a two-housing structure. As shown in FIG. 2 and FIG. 3, the housing of the booster unit 40 includes an outer housing 41 and an inner housing 42 at least partially provided in the outer housing 41, and a fluid channel is formed between the outer housing 41 and the inner housing 42. The fluid inlet port P1 of the booster unit 40 leads to the fluid channel.

The outer housing 41 is in the shape of a cylinder having a bottom. The inner housing 42 includes a body portion 421 in the shape of a cylinder having a bottom, a flange portion 422, and a two-helix fin extending helically on an outer peripheral wall of the body portion 421. The flange portion 422 extends radially outwards from an open end (an upper end of the body portion 421 shown in FIG. 3) of the body portion 421 so as to be substantially aligned with an outer peripheral wall of the outer housing 41, so that when the inner housing 42 is mounted to the outer housing 41, the body portion 421 is located in the outer housing 41, and the flange portion 422 is mounted at an open end (upper ends in FIG. 2 and FIG. 3) of the outer housing 41. Preferably, an outer peripheral edge of the flange portion 422 is substantially aligned with an outer peripheral edge of the outer housing 41, so that the booster unit 40 has a smooth outer contour.

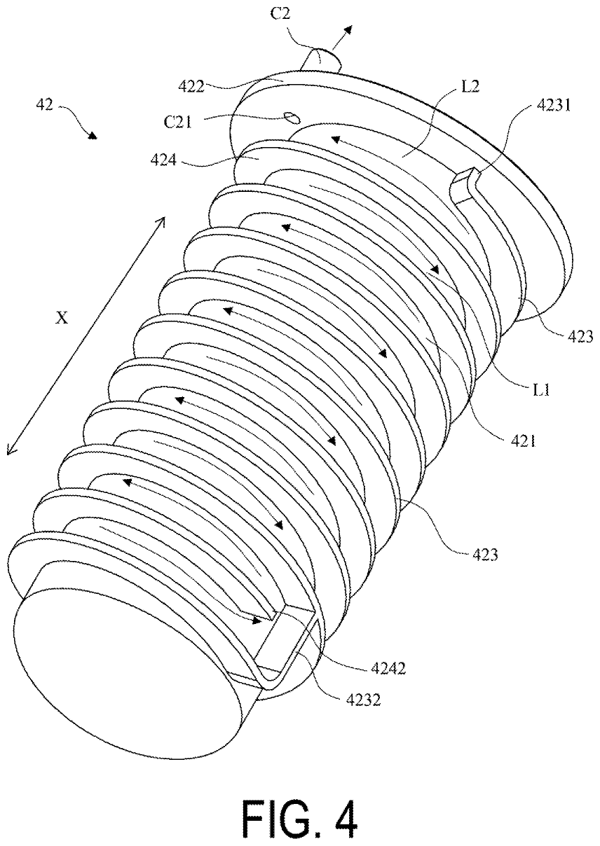

FIG. 4 shows a perspective view of the inner housing 42, and shows the two-helix fin on the outer peripheral wall of the body portion 421 of the inner housing 42. As shown in FIG. 4, the two-helix fin includes a first fin 423 and a second fin 424. Starting from a lower surface of the flange portion 422, the first fin 423 and the second fin 424 respectively helically extend from radially opposite positions in an axial direction (an X direction in the drawing) of the inner housing 42. As most preferably shown in FIG. 4, a first end 4231 of the first fin 423 is connected to the lower surface of the flange portion 422. A first end (not shown) of the second fin 424 is connected to a position on the lower surface of the flange portion 422 radially opposite to the first end 4231 of the first fin. The first fin 423 and the second fin 424 extend helically and alternately with each other in the axial direction of the inner housing 42. Outer diameters of the first fin 423 and the second fin 424 are close to or slightly smaller than an inner diameter of the outer housing 41.

As shown in FIG. 3, when the inner housing 42 is mounted to the outer housing 41, the fluid channel is formed between the outer housing 41 and the inner housing 42, and a fluid inlet of the fluid channel is connected to the fluid inlet port P1 of the booster unit 40. The fluid channel includes a first flow channel L1 and a second flow channel L2 formed between an inner wall of the outer housing 41 and an outer wall of the body portion 421 of the inner housing 42 by the first fin 423 and the second fin 424. The first flow channel L1 and the second flow channel L2 are fluidly connected to each other, and extend helically and alternately with each other in the axial direction of the inner housing 42. The first flow channel L1 and the second flow channel L2 are fluidly connected to each other by causing a second end of one of the first fin 423 and the second fin 424 to be connected to a helical portion thereon and causing the same to be spaced apart from a second end of the other one of the first fin 423 and the second fin 424. As shown in FIG. 3 and FIG. 4, a second end 4232 of the first fin 423 is connected to a helical portion on the first fin 423, and a second end 4242 of the second fin 424 terminates at the second end 4232 of the first fin 423, and is spaced apart therefrom, so that the first flow channel L1 and the second flow channel L2 are fluidly connected to each other herein, and extend helically and alternately with each other in the axial direction, as indicated by arrowed lines in FIG. 3 and FIG. 4. In another example according to the present disclosure not shown, a second end of the second fin 424 is connected to a helical portion on the second fin 424, and a second end of the first fin 423 terminates at the second end of the second fin 424, and is spaced apart therefrom, so that the first flow channel L1 and the second flow channel L2 are fluidly connected to each other.

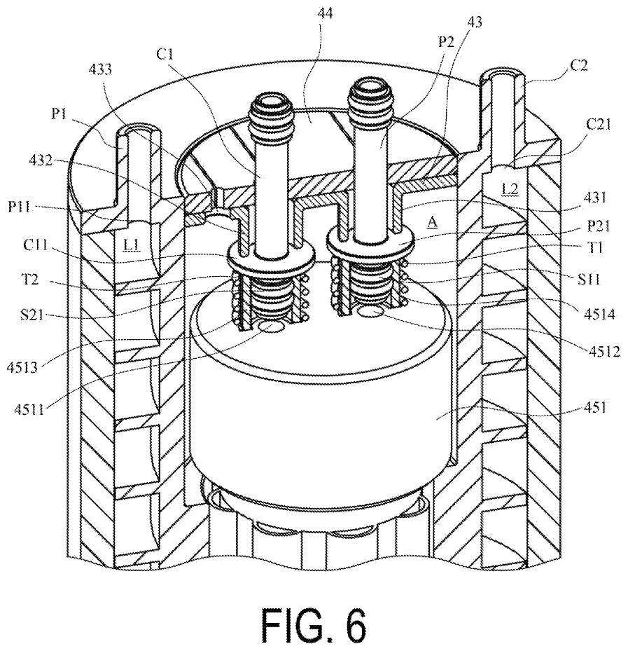

In the embodiment shown in the accompanying drawings, as shown in FIG. 2 and FIG. 3, the booster unit 40 is further provided with a first intermediate port C1 and a second intermediate port C2. A port P11 (please see FIG. 6) of the fluid inlet port P1 is the fluid inlet of the fluid channel between the outer housing 41 and the inner housing 42, and the port P11 leads to the first flow channel L1. A port C21 (please see FIG. 4 and FIG. 6) of the second intermediate port C2 leads to the second flow channel L2, and the port C21 is a fluid outlet of the fluid channel between the outer housing 41 and the inner housing 42. The port C21 is connected to the first intermediate port C1 by means of the second intermediate port C2. A fluid flowing out of the second flow channel L2 of the fluid channel flows to the first intermediate port C1 via the second intermediate port C2.

In the embodiment shown in the accompanying drawings, the fluid inlet port P1 and the second intermediate port C2 are provided on the flange portion 422, and the fluid inlet port P1, the second intermediate port C2, and the flange portion 422 are integrally formed. However, the present disclosure is not limited thereto, and in another example according to the present disclosure, the fluid inlet port P1 and the second intermediate port C2 each may be a port mounted to the flange portion 422, or may be provided in another appropriate position.

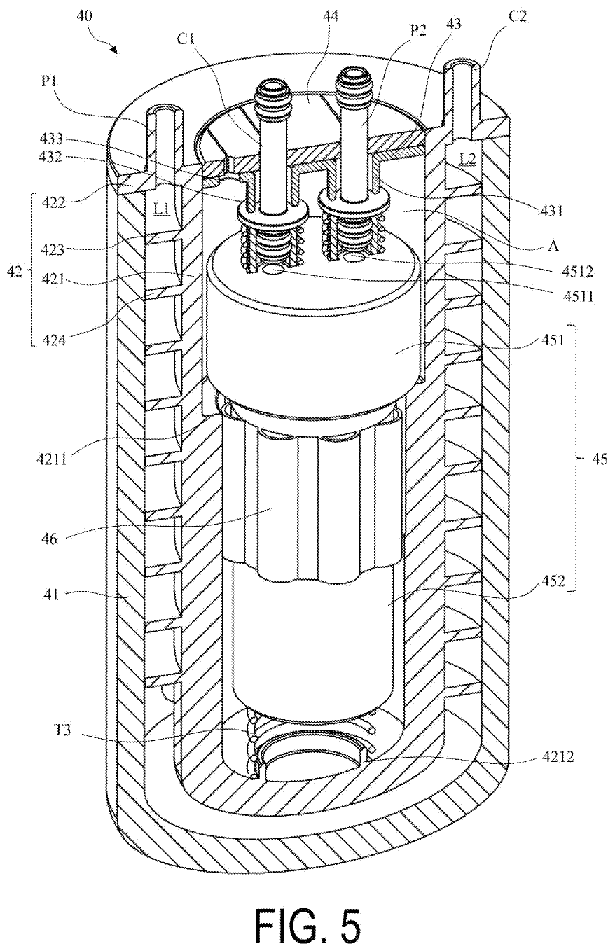

FIG. 5 shows another partial cutaway view of the booster unit 40, and shows an internal structure of the booster unit 40. As shown in FIG. 5, the booster unit 40 further includes a booster pump 45 provided in an inner cavity of the housing, and the housing of the booster unit 40 further includes an upper cover 43. The upper cover 43 is rigid, and is fixed to an inner wall of an open end (an upper end of the inner housing 42 in FIG. 5) of the inner housing 42. The upper cover 43 and the inner housing 42 together define an accommodation space A of the booster unit 40 for accommodating the booster pump 45. The upper cover 43 is provided with a first cylindrical portion 431 through which the fluid outlet port P2 passes and a second cylindrical portion 432 through which the first intermediate port C1 passes. The first cylindrical portion 431 and the second cylindrical portion 432 extend from the upper cover 43 towards the accommodation space A of the booster unit 40 for accommodating the booster pump 45. Inner diameters of the first cylindrical portion 431 and the second cylindrical portion 432 are respectively configured to be greater than outer diameters of the fluid outlet port P2 and the first intermediate port C1, so that the fluid outlet port P2 and the first intermediate port C1 can pass through the same. In addition, the upper cover 43 is further provided with a through hole 433, and the through hole 433 is configured so that a power supply line (not shown) of the booster pump 45 can pass through the same.

As shown in FIG. 5, the booster pump 45 includes a first pump body portion 451 and a second pump body portion 452. FIG. 6 shows an enlarged view of an upper part in FIG. 5. As shown in FIG. 6, the first pump body portion 451 of the booster pump 45 is provided with a pump fluid inlet 4511, a pump fluid outlet 4512, an inlet cylindrical portion 4513 surrounding the pump fluid inlet 4511, and an outlet cylindrical portion 4514 surrounding the pump fluid outlet 4512. The inlet cylindrical portion 4513 and the outlet cylindrical portion 4514 are both fixed to the first pump body portion 451. In the example shown in the drawings, the inlet cylindrical portion 4513, the outlet cylindrical portion 4514, and the first pump body portion 451 are integrally formed. However, in another example according to the present disclosure, the inlet cylindrical portion 4513 and the outlet cylindrical portion 4514 may be separately formed and fixed to the first pump body portion 451, for example, welded to the first pump body portion 451. The fluid outlet port P2 passes through the first cylindrical portion 431 of the upper cover 43, and is joined to the outlet cylindrical portion 4514 by means of a first seal S11, so as to communicate with the pump fluid outlet 4512. The first seal S11 is sleeved on an outer peripheral wall of the fluid outlet port P2, and contacts an inner peripheral surface of the outlet cylindrical portion 4514, so that even when the fluid outlet port P2 moves axially relative to the outlet cylindrical portion 4514, a fluid flowing out of the pump fluid outlet 4512 flows into the fluid outlet port P2, and does not leak to the outside of the outlet cylindrical portion 4514. The first intermediate port C1 passes through the second cylindrical portion 432 of the upper cover 43, and is joined to the inlet cylindrical portion 4513 by means of a second seal S21, so as to communicate with the pump fluid inlet 4511. The second seal S21 is sleeved on an outer peripheral wall of the first intermediate port C1, and contacts an inner peripheral surface of the inlet cylindrical portion 4513, so that even when the first intermediate port C1 moves axially relative to the inlet cylindrical portion 4513, a fluid flowing out of the first intermediate port C1 flows into the pump fluid inlet 4511, and does not leak to the outside of the inlet cylindrical portion 4513. The fluid outlet port P2 and the first intermediate port C1 have substantially the same structure, and a connection between the fluid outlet port P2 and the outlet cylindrical portion 4514 is substantially the same as a connection between the first intermediate port C1 and the inlet cylindrical portion 4513. The following will mainly describe the fluid outlet port P2 and the connection between the fluid outlet port P2 and the outlet cylindrical portion 4514.

As shown in FIG. 6, the fluid outlet port P2 is provided with a first baffle P21. The first baffle P21 is fixed to the outer peripheral wall of the fluid outlet port P2. When the booster unit 40 is assembled in position, the first baffle P21 is axially located between the first cylindrical portion 431 of the upper cover 43 and the outlet cylindrical portion 4514, and is movable between the first cylindrical portion 431 and the outlet cylindrical portion 4514 so as not to contact at least one of the first cylindrical portion 431 and the outlet cylindrical portion 4514. As described above, the fluid outlet port P2 is sealedly joined to the outlet cylindrical portion 4514 by means of the first seal S11, so that even if the first baffle P21 does not contact the outlet cylindrical portion 4514 and an axial gap is present between the first baffle P21 and the outlet cylindrical portion 4514, the fluid flowing out of the pump fluid outlet 4512 does not leak to the outside of the outlet cylindrical portion 4514. In addition, a first upper elastic member T1 is provided around the outlet cylindrical portion 4514. In the example shown in the drawings, the first upper elastic member T1 is a helical spring. The first upper elastic member T1 is provided between an upper surface of the first pump body portion 451 and a lower surface of the first baffle P21, and bias the first baffle P21 towards the first cylindrical portion 431 of the upper cover 43, so that the first baffle P21 may not contact the outlet cylindrical portion 4514, and an axial gap is formed therebetween. An end portion of the fluid outlet port P2 is sealedly joined to the outlet cylindrical portion 4514 by means of the first seal S11, and the fluid outlet port P2 and the outlet cylindrical portion 4514 is axially movable relative to each other, so that the first baffle P21 is axially movable between the first cylindrical portion 431 of the upper cover 43 and the outlet cylindrical portion 4514. The booster pump 45 is fixedly connected to neither one of the housing and the fluid outlet port P2 of the booster unit 40.

Similarly, the first intermediate port C1 is provided with a second baffle C11. The second baffle C11 is fixed to the outer peripheral wall of the first intermediate port C1, is axially located between the second cylindrical portion 432 of the upper cover 43 and the inlet cylindrical portion 4513, and is movable between the second cylindrical portion 432 and the inlet cylindrical portion 4513 so as not to contact at least one of the second cylindrical portion 432 and the inlet cylindrical portion 4513. The first intermediate port C1 is sealedly joined to the inlet cylindrical portion 4513 by means of the second seal S21, so that even if the second baffle C11 does not contact the inlet cylindrical portion 4513 and an axial gap is present between the second baffle C11 and the inlet cylindrical portion 4513, the fluid flowing out of first intermediate port C1 does not leak to the outside of the inlet cylindrical portion 4513. A second upper elastic member T2 is provided around the inlet cylindrical portion 4513, and the second upper elastic member T2 bias the second baffle C11 towards the second cylindrical portion 432. In the example shown in the drawings, the second upper elastic member T2 is a helical spring. An end portion of the first intermediate port C1 is sealedly joined to the inlet cylindrical portion 4513 by means of the second seal S21, and the first intermediate port C1 and the inlet cylindrical portion 4513 is axially movable relative to each other, so that the second baffle C11 is axially movable between the second cylindrical portion 432 of the upper cover 43 and the inlet cylindrical portion 4513. The booster pump 45 is fixedly connected to neither one of the housing and the first intermediate port C1 of the booster unit 40.

In addition, as shown in FIG. 5, an annular flange 4212 is formed in the center of the bottom of the inner cavity of the inner housing 42, and a lower elastic member T3 is provided around the annular flange 4212, and is used to support the booster pump 45. In the example shown in the drawings, the lower elastic member T3 is a helical spring. The booster pump 45 is disposed on the lower elastic member T3. The booster pump 45 is not fixedly connected to the bottom of the inner housing 42, and is axially movable relative to the inner housing 42.

By means of the above configurations, the booster pump 45 is fixedly connected to none of the housing, the first intermediate port C1, and the fluid outlet port P2, and is movable relative to the same, thereby forming flexible connections, and providing axial flexibility. When the booster pump 45 in operation vibrates, the booster pump 45 is axially movable relative to the housing, the first intermediate port C1, and the fluid outlet port P2 of the booster unit 40, thereby preventing vibration of the booster pump 45 from being transmitted to the housing of the booster unit 40. In addition, the above rigid upper cover 43 limits a rang in which the booster pump 45 moves axially upwards in the housing. In addition, as shown in FIG. 5, a step portion 4211 is formed on an inner wall of the inner housing 42. An inner diameter of the step portion 4211 is less than an outer diameter of the first pump body portion 451 of the booster pump 45, and is greater than an outer diameter of the second pump body portion 452 of the booster pump 45. The first pump body portion 451 of the booster pump 45 is located axially above the step portion 4211. By means of the above configurations of the step portion 4211 and the first pump body portion 451 of the booster pump 45, a range in which the booster pump 45 moves axially downwards in the accommodation space in the housing can be limited. By means of the above configurations, the booster pump 45 can be restricted in the accommodation space A in the housing of the booster unit 40, and is axially movable in an allowable range. In addition, the first baffle P21 and the second baffle C11 can prevent a case: the fluid outlet port P2 and the first intermediate port C1 are accidentally pulled out, and are therefore respectively disjoined from the outlet cylindrical portion 4514 and inlet cylindrical portion 4513, resulting in leakage. Therefore, the fluid outlet port P2 and the first intermediate port C1 are constantly sealedly joined to the outlet cylindrical portion 4514 and the inlet cylindrical portion 4513 of the booster pump 45, respectively.

As shown in FIG. 5 and FIG. 6, preferably, the booster unit 40 is further provided with a flexible mat 44 covering the upper cover 43. The flexible mat 44 is provided with three through holes corresponding to the first cylindrical portion 431, the second cylindrical portion 432, and the through hole 433 of the upper cover 43, so as to allow the fluid outlet port P2, the first intermediate port C1, and the power supply line to respectively pass through the same. The flexible mat 44 further prevents noise generated by the booster pump 45 in operation from being transmitted to the outside of the housing of the booster unit 40, thereby reducing noise of the booster unit 40 as a whole in operation. The three through holes in the flexible mat 44 can be configured to have diameters as small as possible while allowing the first intermediate port C1, the fluid outlet port P2, and the power supply line to respectively pass through the same, so that noise is effectively isolated, and the first intermediate port C1, the fluid outlet port P2, and the power supply line are retained.

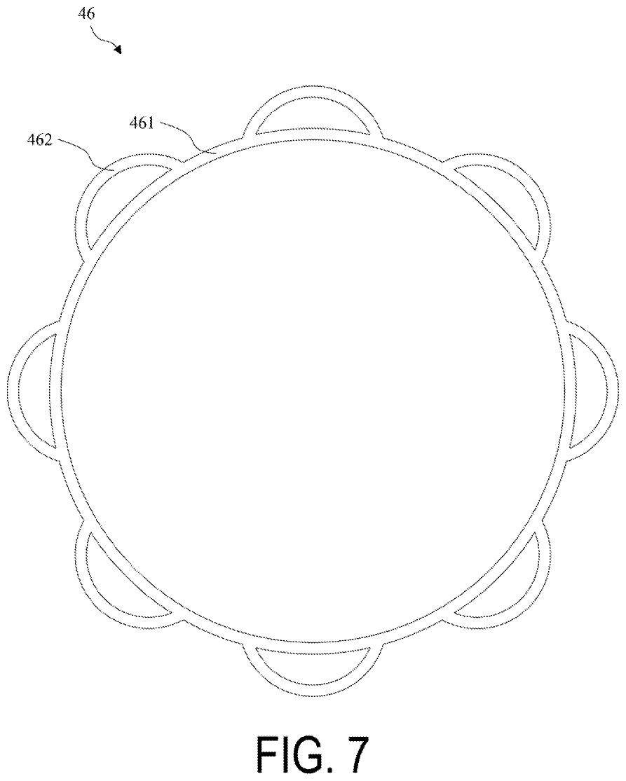

In addition, as shown in FIG. 5, the booster unit 40 is further provided with a cushion 46. The cushion 46 is provided between an outer peripheral wall of the second pump body portion 452 of the booster pump 45 and the inner wall of the inner housing 42. The cushion 46 is made from a flexible material. In the example shown in the drawings, the cushion 46 is in the form of a cushioning sleeve. FIG. 7 shows a top view of the cushion 46 viewed axially. As shown in FIG. 7, the cushion 46 includes an annular body portion 461 and a plurality of arc-shaped portions 462 provided at equal intervals along the outer periphery of the annular body portion 461. The arc-shaped portions 462 and the annular body portion 461 are integrally formed, and a gap is formed between each arc-shaped portion 462 and the annular body portion 461. The cushion 46 causes the booster pump 45 to have radial flexibility so that when the booster pump 45 in operation vibrates and therefore moves radially, the booster pump 45 is prevented from directly contacting the inner wall of the inner housing 42, thereby preventing noise and vibration from being transmitted to the housing of the booster unit 40. In addition, when the booster unit 40 operates horizontally, the cushion 46 can prevent the inlet cylindrical portion 4513 and the outlet cylindrical portion 4514 of the booster pump 45 from being incorrectly aligned with the first intermediate port C1 and the fluid outlet port P2, and alleviate pressure from the booster pump 45 to the first seal S11 on the fluid outlet port P2 and the second seal S21 on the first intermediate port C1, thereby alleviating deformation of the first seal S11 and the second seal S21, ensuring that the booster pump 45 is sealedly connected to the fluid outlet port P2 and the first intermediate port C1, and preventing leakage.

The above describes the structure of the booster unit 40 according to the present disclosure. The following will describe with reference to the accompanying drawings a working process of the booster unit 40 and the reverse osmosis filtration system 100 according to the first embodiment of the present disclosure.

When a switch 31 of the faucet 30 is turned on, raw water (municipal tap water) flows through the preliminary filter unit 10, and purified water obtained after filtration performed by the preliminary filter unit 10 flows to the booster unit 40 via the water intake solenoid valve V1. The purified water flows to the fluid inlet port P1 of the booster unit 40, enters the housing of the booster unit 40, flows along the helical first flow channel L1 between the outer housing 41 and the inner housing 42 to the helical second flow channel L2, flows out of the housing, and flows into the booster pump 45 via the second intermediate port C2 and the first intermediate port C1, as indicated by the arrowed lines in FIG. 3. Before the purified water flows into the booster pump 45, the purified water flows helically in the fluid channel between the outer housing 41 and the inner housing 42, so that on the one hand, the purified water flowing outside the booster pump 45 forms a fluid acoustic barrier, thereby restricting noise generated by the booster pump 45 in operation from propagating to the outside of the housing of the booster unit 40. On the other hand, the purified water flows helically between the outer housing 41 and the inner housing 42, thereby increasing a contact area between the flowing purified water and the housing, extending duration of contact between the purified water and the housing, therefore enhancing a cooling effect, and facilitating heat dissipation of the booster pump 45. In addition, the purified water to be pressurized by the booster pump 45 flows as a cooling medium in the housing to perform cooling, so that no additional coolant or cooling apparatus needs to be provided, thereby reducing costs and simplifying design. Additionally, the purified water flowing in the housing outside the booster pump 45 does not contact the booster pump 45, so that the purified water does not contact the power supply line of the booster pump 45 or the like, thereby improving safety.

The fluid flowing out of the second flow channel L2 in the housing of the booster unit 40 flows to the first intermediate port C1 via the second intermediate port C2, flows from the first intermediate port C1 into the booster pump 45 via the pump fluid inlet 4511, and is pressurized by the booster pump 45. As described above, the booster pump 45 is fixedly connected to none of the housing of the booster unit 40, the first intermediate port C1, and the fluid outlet port P2, and is movable relative to the same, thereby forming flexible connections, and providing axial flexibility. The cushion 46 provides radial flexibility. The purified water forms the fluid acoustic barrier in the housing. The upper cover 43 is provided with the flexible mat 44. The above configurations all facilitate restriction of transmission of vibration and noise. Therefore, even if the booster pump 45 in operation generates vibration and noise, the vibration generated by the booster pump 45 is prevented from being transmitted to the housing of the booster unit 40, and the noise is restricted from being transmitted to the outside of the housing of the booster unit 40.

After being pressurized by the booster unit 40, the purified water flows out of the fluid outlet port P2 of the booster unit 40, flows to the reverse osmosis filter unit 20, and flows into the water inlet 211 of the reverse osmosis membrane filter element 21. After the reverse osmosis membrane filter element 21 performs further treatment, pure water flows to the faucet 30 via the check valve 22, and flows out of a water outlet 32, so as to be used. When water pressure in a raw water pipeline is too low, for example when a municipal tap water pipeline stops supplying water, and no raw water is present in the raw water pipeline of the reverse osmosis filtration system 100, the low-pressure protection switch 51 causes the booster unit 40 to stop operating, prevents the booster pump 45 from operating idly, stops supplying water to the reverse osmosis filter unit 20, and causes the reverse osmosis filter unit 20 to stop operating. When the water storage tank of the reverse osmosis filter unit 20 is filled up with pure water or the pressure in the downstream pipeline of the check valve 22 reaches the predetermined pressure value, the high-pressure protection switch 52 causes the booster unit 40 to stop operating, stops supplying water to the reverse osmosis filter unit 20, and causes the reverse osmosis filter unit 20 to stop producing water.

The above describes the booster unit 40 and the reverse osmosis filtration system 100 having the booster unit 40 according to the first embodiment of the present disclosure. In the booster unit 40 according to the first embodiment of the present disclosure, the two-layer housing structure having the outer housing and the inner housing is provided; the fluid channel is formed between the outer housing and the inner housing; the booster pump 45 is configured not to be fixedly connected to the housing, and the booster pump 45 and the housing is movable relative to each other, thereby forming a flexible connection; before flowing into the booster pump 45, purified water is caused to flow in the fluid channel between the outer housing and the inner housing, thereby preventing vibration generated by the booster pump 45 in operation from being transmitted to the housing, restricting noise generated by the booster pump 45 in operation from being transmitted to the outside of the housing, and therefore effectively reducing vibration and noise. In addition, the purified water to be pressurized by the booster pump 45 flows as a cooling medium in the housing to perform effective cooling, thereby reducing costs and simplifying design.

The above applications of the present disclosure in municipal tap water filtration show the booster unit and the reverse osmosis filtration system according to the preferred embodiments of the present disclosure. However, the present disclosure is not limited to the above preferred embodiments. Modifications can be made to the above preferred embodiments on the basis of the ideas of the present disclosure, and these modifications all fall within the scope of the present disclosure.

In the above preferred embodiments, the inner housing 42 is provided with the flange portion 422, and the fluid inlet port P1 and the second intermediate port C2 are both provided on the flange portion 422 of the inner housing 42, and are located in radially opposite positions. However, the present disclosure is not limited thereto. In another embodiment according to the present disclosure, the fluid inlet port P1 and the second intermediate port C2 can be provided in other positions. For example, in an example according to the present disclosure, one or both of the fluid inlet port P1 and the second intermediate port C2 can be formed at the open end of the outer housing 41; the fluid inlet port P1 leads to the first flow channel L1; the second intermediate port C2 leads to the second flow channel L2. In another example according to the present disclosure, the inner housing 42 may not be provided with the flange portion 422; the inner housing 42 is completely mounted in the outer housing 41, and the open end of the inner housing 42 is lower than the open end of the outer housing 41; the upper cover 43 may be mounted at the open end of the inner housing 42, and fixed to the inner wall of the outer housing 41, and the fluid inlet port P1 and the second intermediate port C2 are correspondingly provided on the upper cover 43.

In the above preferred embodiments, the fluid outlet port P2 is provided with the first baffle P21; the first intermediate port C1 is provided with the second baffle C11; the first upper elastic member T1 is provided around the outlet cylindrical portion 4514, and the second upper elastic member T2 is provided around the inlet cylindrical portion 4513; the booster pump 45 is axially movable relative to the housing, the fluid outlet port P2, and the first intermediate port C1 of the booster unit 40, thereby providing the axial flexibility, restricting a range in which the booster pump 45 moves axially, and preventing the fluid outlet port P2 and the first intermediate port C1 from being disjoined from the outlet cylindrical portion 4514 and the inlet cylindrical portion 4513 of the booster pump 45. However, the present disclosure is not limited thereto. In an embodiment according to the present disclosure, as long as the first baffle P21 and the second baffle C11 is axially movable between lower end portions of the first cylindrical portion 431 and the second cylindrical portion 432 of the upper cover 43 and upper end portions of the outlet cylindrical portion 4514 and the inlet cylindrical portion 4513 of the booster pump 45, and do not move downwards to the outlet cylindrical portion 4514 and the inlet cylindrical portion 4513 due to the gravity thereof, the first upper elastic member T1 and the second upper elastic member T2 do not need to be provided in order to cause the booster pump 45 to have the axial flexibility, restrict the range in which the booster pump 45 moves axially, and prevent the first intermediate port C1 and the fluid outlet port P2 from being disjoined from the inlet cylindrical portion 4513 and the outlet cylindrical portion 4514 of the booster pump 45. In another embodiment according to the present disclosure, the lower end portions of the first cylindrical portion 431 and the second cylindrical portion 432 of the upper cover 43 and the upper end portions of the outlet cylindrical portion 4514 and the inlet cylindrical portion 4513 of the booster pump 45 may be axially aligned with each other and spaced apart from each other, and the first baffle P21, the second baffle C11, the first upper elastic member T1, and the second upper elastic member T2 do not need to be provided in order to cause the booster pump 45 to have axial flexibility and restrict the range in which the booster pump 45 moves axially. In the variation example, another stopping structure can be provided as required to prevent the first intermediate port C1 and the fluid outlet port P2 from being disjoined from the inlet cylindrical portion 4513 and the outlet cylindrical portion 4514 the booster pump 45.

In the above preferred embodiments, the upper cover 43 is provided with the first cylindrical portion 431 through which the fluid outlet port P2 passes and the second cylindrical portion 432 through which the first intermediate port C1 passes, and the range in which the booster pump 45 moves axially is restricted by means of axial spacing between the lower end portions of the first cylindrical portion 431 and the second cylindrical portion 432 and the upper end portions of the outlet cylindrical portion 4514 and the inlet cylindrical portion 4513 of the booster pump 45. However, the present disclosure is not limited thereto. In another embodiment according to the present disclosure, the upper cover 43 can be provided with only through holes through which the fluid outlet port P2 and the first intermediate port C1 pass, and are not provided the first cylindrical portion 431 and the second cylindrical portion 432, and the range in which the booster pump 45 moves axially is restricted by configuring a position in which the upper cover 43 is fixed axially relative to the inner housing 42.

In the above preferred embodiments, the two-helix fin extends helically axially on the outer peripheral wall of the body portion 421, so as to form the helical first flow channel L1 and the helical second flow channel L2. However, the present disclosure is not limited thereto. In another embodiment according to the present disclosure, the fluid channel between the inner housing and the outer housing can be formed in other forms. For example, in an example according to the present disclosure, the two-helix fin can be formed on the inner wall of the outer housing 41, and the two-helix fin and the inner housing 42 together form the helical first flow channel and the helical second flow channel. In another example according to the present disclosure, the fluid channel in which a fluid flows and that is located between the outer housing 41 and the inner housing 42 can be formed to extend axially to be S-shaped, so that the purified water entering the housing flows back and forth in the axial direction of the housing between the outer housing and the inner housing. In still another example according to the present disclosure, the fluid channel in which a fluid flows and that is located between the outer housing 41 and the inner housing 42 can be a pipe meandering between the outer housing 41 and the inner housing 42.

In the above preferred embodiments, one cushion 46 is provided on the periphery of the second pump body portion 452 of the booster pump 45. However, the present disclosure is not limited thereto. In other embodiments according to the present disclosure, the number, shape, and axial height of cushions 46 are not specially limited. As required, two or more cushions spaced apart from each other can be provided on the second pump body portion 452 of the booster pump 45, and the shape of the cushions is not limited to the shape shown in FIG. 7.

In the above preferred embodiments, the booster unit 40 is provided with the first intermediate port C1 and the second intermediate port C2; an outlet of the fluid channel between the outer housing 41 and the inner housing 42 leads to the first intermediate port C1 by means of the second intermediate port C2; one end of the first intermediate port C1 is sealedly connected to the inlet cylindrical portion 4513 by means of the second seal S21, and another end of the first intermediate port C1 passes through the upper cover 43 and the flexible mat 44, and is located outside the accommodation space of the booster unit 40. However, the present disclosure is not limited thereto. In an embodiment according to the present disclosure, if allowed by space in the inner cavity of the inner housing, the first intermediate port C1 can be connected, in the inner cavity of the inner housing 42, to the second flow channel L2, for example, connected to the second flow channel L2 via an opening on a peripheral wall of the body portion 421 of the inner housing 42, so that the second intermediate port C2 does not need to be provided, and the through holes through which the first intermediate port C1 passes do not need to be proved on the upper cover 43 and the flexible mat 44.

In the above preferred embodiments, the booster unit 40 is for the reverse osmosis filtration system 100, and is used to increase intake water pressure of the reverse osmosis membrane filter element. However, the present disclosure is not limited thereto. The booster unit according to the present disclosure can also be used in other devices to increase pressure of a fluid.

Herein, the exemplary embodiments of the present disclosure have been described in detail with reference to the applications of the reverse osmosis filtration system according to the present disclosure in the municipal tap water filtration. However, it should be understood that the present disclosure is not limited to the above detailed description and the specific embodiments shown. Those skilled in the art can make various variations and variants of the present disclosure without departing from the gist and scope of the present disclosure. All these variations and variants fall within the scope of the present disclosure. In addition, all members described herein can be replaced with other technically equivalent members.

1. A booster unit, provided with a fluid inlet port and a fluid outlet port, the booster unit comprising:
a booster pump, provided with a pump fluid inlet and a pump fluid outlet, wherein the pump fluid outlet is connected to the fluid outlet port; and
a housing, provided in the housing,
wherein the housing comprises an outer housing and an inner housing; the inner housing is at least partially mounted in the outer housing; the booster pump is provided in an inner cavity of the inner housing; and
a fluid channel is formed between the outer housing and the inner housing; a fluid inlet of the fluid channel is connected to the fluid inlet port, and a fluid outlet of the fluid channel is connected to the pump fluid inlet.

2. The booster unit according to claim 1, wherein the booster pump is configured to be movable relative to the housing.

3. The booster unit according to claim 2, wherein the housing further comprises an upper cover, and the upper cover is mounted to an open end of the inner housing so that the upper cover and the inner housing together define an accommodation space for accommodating the booster pump;
wherein the bottom of the booster pump is supported by a lower elastic member so that the booster pump is configured to be movable in an axial direction of the housing in the accommodation space.

4. The booster unit according to claim 3, wherein
the booster pump is provided with an inlet cylindrical portion surrounding the pump fluid inlet and an outlet cylindrical portion surrounding the pump fluid outlet; one end of the fluid outlet port passes through the upper cover and is sealedly joined to the outlet cylindrical portion, and the fluid outlet port is movable in the axial direction relative to the outlet cylindrical portion; and
the booster unit is further provided with a first intermediate port; one end of the first intermediate port is sealedly joined to the inlet cylindrical portion; another end of the first intermediate port is fluidly connected to the fluid outlet of the fluid channel; the first intermediate port is movable in the axial direction relative to the inlet cylindrical portion.

5. The booster unit according to claim 4, wherein the booster unit further comprises a first seal and a second seal; the one end of the fluid outlet port is sealedly joined to the outlet cylindrical portion by means of the first seal, and the one end of the first intermediate port is sealedly joined to the inlet cylindrical portion by means of the second seal.

6. The booster unit according to claim 4, wherein the another end of the first intermediate port is fluidly connected to the fluid outlet of the fluid channel by means of a second intermediate port.

7. The booster unit according to claim 6, wherein
the upper cover is provided with a first cylindrical portion through which the fluid outlet port passes and a second cylindrical portion through which the first intermediate port passes; and
the first cylindrical portion and the second cylindrical portion extend from the upper cover towards the inside of the accommodation space; the first cylindrical portion is adapted to be spaced apart from the outlet cylindrical portion in the axial direction, and the second cylindrical portion is adapted to be spaced apart from the inlet cylindrical portion in the axial direction.

8. The booster unit according to claim 7, wherein the first cylindrical portion is aligned with the outlet cylindrical portion, and/or the second cylindrical portion is aligned with the inlet cylindrical portion.

9. The booster unit according to claim 7, wherein
a first baffle is fixed to the fluid outlet port, the first baffle is located between the first cylindrical portion and the outlet cylindrical portion in the axial direction; and
a second baffle is fixed to the first intermediate port, the second baffle is located between the second cylindrical portion and the inlet cylindrical portion in the axial direction.

10. The booster unit according to claim 9, wherein the booster unit is provided with a first upper elastic member and a second upper elastic member;
the first upper elastic member surrounds the outlet cylindrical portion, and is configured to bias the first baffle towards the first cylindrical portion; and
the second upper elastic member surrounds the inlet cylindrical portion, and is configured to bias the second baffle towards the second cylindrical portion.

11. The booster unit according to claim 3, wherein the booster unit is further provided with a flexible mat, and the flexible mat is configured to cover the upper cover.

12. The booster unit according to claim 1, wherein the booster unit is further provided with a cushion, and the cushion is provided between an outer peripheral wall of the booster pump and an inner wall of the inner housing.

13. The booster unit according to claim 1, wherein the fluid channel extends helically in the axial direction of the housing.

14. The booster unit according to claim 13, wherein the fluid channel comprises a first flow channel and a second flow channel; the first flow channel and the second flow channel are fluidly connected to each other, and extend helically and alternately with each other in the axial direction of the housing; the first flow channel has the fluid inlet, and the second flow channel has the fluid outlet.

15. A reverse osmosis filtration system, comprising:
a preliminary filter unit, configured to filter raw water to obtain purified water; and
a reverse osmosis filter unit, configured to further filter the purified water flowing out of the preliminary filter unit,
wherein the reverse osmosis filtration system further comprises the booster unit according to claim 1, and the booster unit is provided upstream of a water inlet of the reverse osmosis filter unit.

16. The reverse osmosis filtration system according to claim 15, wherein an outlet of the preliminary filter unit is connected to the fluid inlet port of the booster unit, and the fluid outlet port of the booster unit is connected to the water inlet of the reverse osmosis filter unit.
